(19) United States
(12) Patent Application Publication
(10) Pub. No.: US 2021/0287287 A1
(43) Pub. Date: Sep. 16, 2021

(54) Systems and Methods for Generating Ordered Operation Sets According to Time-Series Data Projections

(71) Applicant: TD Ameritrade IP Company, Inc., Omaha, NE (US)

(72) Inventor: Harrison W. NAPPER, Chicago, IL (US)

(21) Appl. No.: 16/814,948

(22) Filed: Mar. 10, 2020

(51) Int. Cl. G06Q 40/04; G06F 16/953

(52) U.S. Cl. CPC G06Q 40/04; G06F 16/953

(57) ABSTRACT

A system includes a stock and option parameter database including records for multiple options and instructions for execution by at least one processor. The instructions include, in response to receiving user parameters including a stock identifier, a future value, a future date, and a requested amount, obtaining a set of options. The instructions include, for each option of the set of options, in response to an expiration date of the option being after the future date, determining an acquired quantity of the option based on the requested amount. The instructions include, in response to the acquired quantity being greater than zero, determining a theoretical value based on a difference between a theoretical future value and a theoretical present value. The instructions include, in response to the theoretical value being greater than a beginning value, adding the option to a candidate list and outputting the candidate list to a user device.

### FIELD

The present disclosure relates to systems and methods of database querying and more particularly to generating result sets from database queries based on time-series data projections.

### BACKGROUND

Options trading can be difficult for users to understand as there are an innumerable number of different options that can be traded. Multiple factors can influence the overall profitability of an options trade and users may have a hard time understanding the impact each of these factors has on the overall profitability. By focusing on the maximum return over time, meaningful value and options interpretations is provided to users.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system includes at least one processor and a memory coupled to the at least one processor. The memory stores a stock and option parameter database including a plurality of options. Each option of the plurality of options includes a corresponding stock symbol, a value, and an expiration date. The memory stores instructions for execution by the at least one processor. The instructions include, in response to receiving user parameters including a stock identifier, a future value, a future date, and a requested amount, obtaining a set of options based on the stock identifier from the stock and option parameter database. The instructions include, for each option of the set of options, in response to an expiration date of the option being after the future date, determining an acquired quantity of the option based on the requested amount. The instructions include, in response to the acquired quantity being greater than zero, determining a theoretical value based on a difference between a theoretical future value and a theoretical present value. The theoretical future value is based on the future value. The instructions include, in response to the theoretical value being greater than a beginning value, adding the option to a candidate list. The instructions include outputting the candidate list to a user device.

In other features, outputting includes outputting an aural representation of at least one option of the candidate list via a speaker of the user device. In other features, outputting includes outputting a graphical representation of at least one option of the candidate list via a display screen of the user device. In other features, the instructions include identifying a highest option from the candidate list and the highest option includes a highest theoretical value among the options in the candidate list. In other features, only the highest option is initially output via the user device. In other features, the instructions include automatically actuating a purchase of an option corresponding to the highest option.

In other features, the instructions include sorting the candidate list based on a theoretical value of each option of the set of options and displaying the sorted candidate list. In other features, the theoretical future value and the theoretical present value are based on a Black-Scholes model. In other features, the instructions include automatically setting an alert to actuate a sale on the future date.

In other features, the memory stores an account parameter database including a plurality of accounts. In other features, each account of the plurality of accounts includes an amount of available funds. In other features, the user parameters include a requesting account of the plurality of accounts, and the requested amount is determined based a requesting amount of available funds included in the requesting account. In other features, the user parameters are received as user input via the user device.

A method includes, in response to receiving user parameters including a stock identifier, a future value, a future date, and a requested amount, obtaining a set of options based on the stock identifier from a stock and option parameter database. The stock and option parameter database includes a plurality of options. Each option of the plurality of options includes a corresponding stock symbol, a value, and an expiration date. The method includes, for each option of the set of options, in response to an expiration date of the option being after the future date, determining an acquired quantity of the option based on the requested amount. The method includes, in response to the acquired quantity being greater than zero, determining a theoretical value based on a difference between a theoretical future value and a theoretical present value. The theoretical future value is based on the future value. The method includes, in response to the theoretical value being greater than a beginning value, adding the option to a candidate list. The method includes outputting the candidate list to a user device.

In other features, the method includes outputting an aural representation of at least one option of the candidate list via a speaker of the user device. In other features, the method includes outputting a graphical representation of at least one option of the candidate list via a display screen of the user device. In other features, the method includes identifying a highest option from the candidate list, wherein the highest option includes a highest theoretical value among the options in the candidate list. In other features, only the highest option is initially output via the user device.

In other features, the method includes automatically actuating a purchase of an option corresponding to the highest option. In other features, the method includes automatically setting an alert to actuate a sale on the future date. In other features, the method includes sorting the candidate list based on a theoretical value of each option of the set of options and displaying the sorted candidate list. In other features, the theoretical future value and the theoretical present value are based on a Black-Scholes model.

In other features, the method includes storing a plurality of accounts. In other features, each account of the plurality of accounts includes an amount of available funds. In other features, the user parameters include a requesting account of the plurality of accounts. In other features, the requested amount is determined based a requesting amount of available funds included in the requesting account. In other features, the user parameters are received as user input via the user device.

Further areas of applicability of the present disclosure will become apparent from the detailed description, the claims, and the drawings. The detailed description and specific examples are intended for purposes of illustration only and are not intended to limit the scope of the disclosure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a high-level example block diagram of a user-guided options generation system.

FIGS. 2A-2C are representations of an example user interface presenting example user input and example results according to principles of the present disclosure.

FIG. 3 is a functional block diagram of an example user-guided generation module according to principles of the present disclosure.

FIG. 4 is a flowchart depicting example results generation and display according to principles of the present disclosure.

FIG. 5 is a flowchart depicting example actuation of purchase and sale of an option according to principles of the present disclosure.

In the drawings, reference numbers may be reused to identify similar and/or identical elements.

### DETAILED DESCRIPTION

### Introduction

A user-guided options generation system informs a user of a theoretical yield of a stock versus a theoretical yield of a variety of stock options, allowing the user to make a more informed purchase. The user-guided options generation system receives input from the user indicating a stock the user would like to purchase. The user further provides an estimated future value of the stock at a future date. The estimated future value can be a single value or the user may draw a path on a touch screen of a user system to estimate the stock's trajectory for a period.

Then, the user-guided options generation system provides the user with a variety of stock options and corresponding theoretical yields of the stock options in percentage or monetary form. In various implementations, the user-guided options generation system may also provide the user with a probability the stock will reach the estimated future value at the future date, a maximum loss, and a maximum gain. The user-guided options generation system also determines a stock yield by the expiration date of the corresponding stock option to which the stock is being compared.

The theoretical yield of the variety of stock options may be calculated based on a maximum amount the user is willing to invest or a number of stocks the user is willing to invest in a stock option over the actual stock. In this way, the user may easily compare potential gain as well as a risk involved when purchasing a particular stock option.

In various implementations, the user-guided options generation system receives input from the user indicating a stock the user would like to sell, allowing for price decrease projections. Additionally, the user-guided options generation system can generate non-linear price projections. While displaying the theoretical yield of the stock position is informative for the user, the user-guided options generation system is further considering the stock as an available investment option or trade to return the highest theoretical return on capital trade for the user-specified projection.

Overall, the user-guided options generation system is intended to help the user focus on or highlight for the user the current value of a given stock or option, allow the user to make a projection on that value, and identify the maximum return along the projection of the stock or option. In various implementations, the user-guided options generation system can generate projections for volatility and risk-free rate, projection ranges, a plurality of projections driving a single output (whether for a single symbol or multiple symbols), spreads (as opposed to only single options) as output trades, and auto-rolling trades. For auto-rolling trades, the user-guided options generation system is constantly scanning the entire market for the user's projections and identifying a collection of trades resulting in the highest instantaneous rate of growth for the user's account.

### Block Diagram

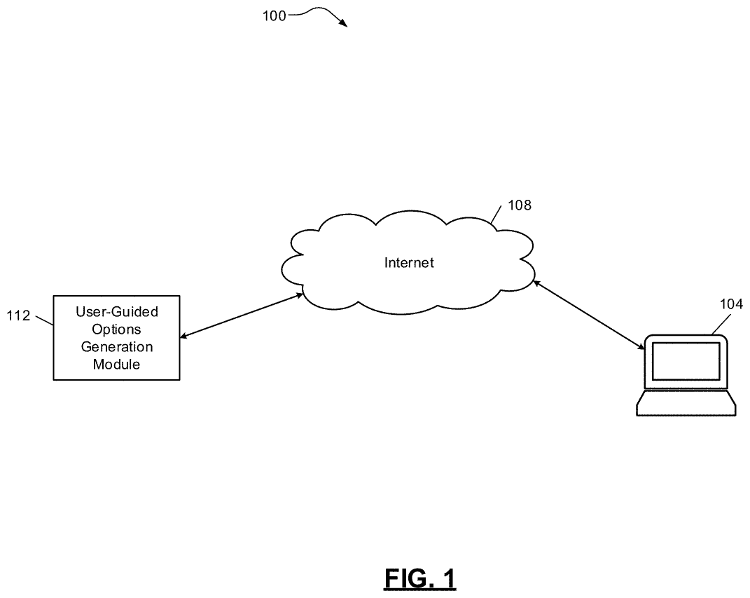

Referring to FIG. 1, a high-level example block diagram of a user-guided options generation system 100 is shown. A user device, such as a computer, tablet, mobile phone, etc., can connect to the Internet 108 to access a user-guided generation module 112. The user-guided generation module 112 receives user input from a user operating the user device 104 via the Internet 108. The user input includes a stock, a future value, a future date, and an amount. The amount may be a monetary amount the user is willing to risk or a number of stocks that the user is willing to purchase in stock options instead of the stock.

Once user input is received, the user-guided generation module 112 determines a theoretical yield at the future date of a variety of stock options of the stock. The theoretical yield or annual yield indicates an amount of the user's investment that is received during the length of time the user holds the stock option. For example, the theoretical yield is a percentage of the amount provided by the user that the user will theoretically receive by the future date if the user's estimated future value is accurate. Since the theoretical yield is theoretical, the user-guided generation module 112 may also determine a probability (suggesting an amount of risk) that the stock will reach the estimated price within the number of days until expiration of the stock option. Both the theoretical yield and the probability may be determined according to the Black-Scholes pricing model and known pricing estimation models.

In various implementations, the theoretical yield may be determined over a duration of the specified projection, duration of a single trade, or duration of a user-specified period. For example, the user may project that a company will increase by 10% in a five-month period without any projections beyond the five-month period. In this example, the highest yield trade may be a call yielding 10% over one week, which might be a 420% yield annually or a 120% yield over the five-month period. Therefore, the user-guided generation options system 100 compares the same amount of time period which are, for example, daily, so that the comparison can be made over the same duration.

### Example User Interfaces

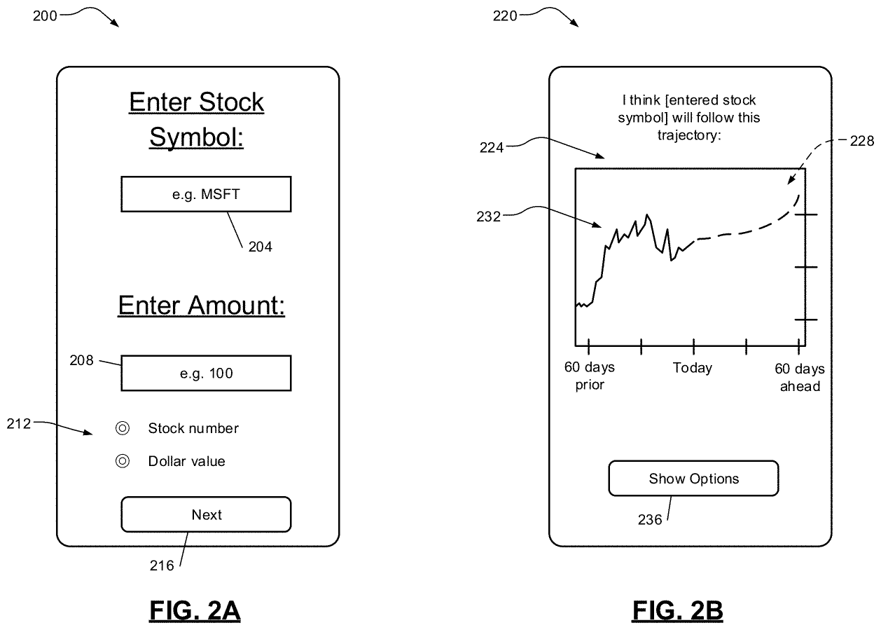

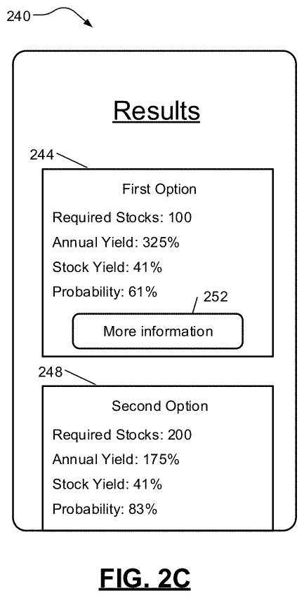

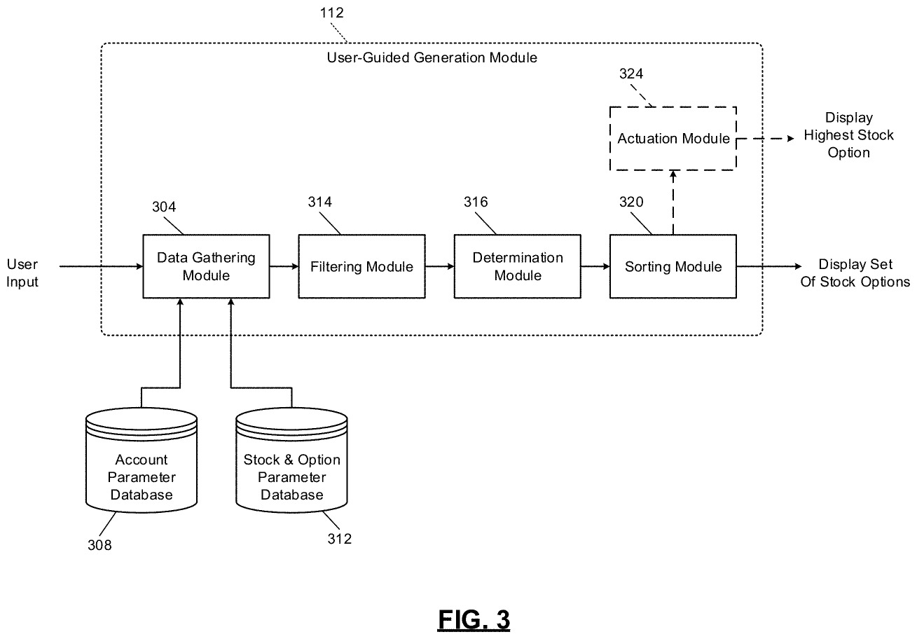

Referring now to FIGS. 2A-2C, representations of an example user interface presenting example user input and example results are shown. FIG. 2A depicts a user-guided options generation application operated on a mobile device, such as a phone. In various implementations, the user may log into the user-guided options generation application, which may be operated by an entity associated with the user's financial account. Therefore, upon login, the user-guided options generation application has access to the user's account parameters, including an available amount of funds or an indication of buying power. Therefore, based on the user input, the user-guided generation application may alert if an options purchase would require the use of reserved funds. In various implementations, the user's account parameters may be provided as inputs.

Upon selection of the user-guided options generation application, a selection display screen 200 is displayed to the user. As described above, the user-guided options generation application is operated by the user-guided generation module to provide a variety of stock options that the user can purchase along with a theoretical yield and probability of realizing the theoretical yield. On the selection display screen 200, the user is prompted to enter a stock symbol in a stock entry field 204, for example, MSFT. The user also enters an amount in an amount entry field 208, using radio buttons 212 to selection whether the amount corresponds to a number of stocks or a dollar value. Upon selection of a next button 216, the user-guided options generation application continues to a trajectory screen 220 of FIG. 2B.

In various implementations, the user-guided options generation application may compare a collection of symbols' collective price change providing that the user predicts a change in the value of a factor that influences price of the collection of symbols (for example, a user may predict oil prices will go up or down in a particular projection). Once such a prediction is input, the user-guided options generation application would scan a whole host of symbols and all possible trades to find the optimum profit if that predicted change occurs in a similar manner that is predicted.

In a further example, the user can enter one or more symbols and projections, such as: (i) set of symbols with corresponding projections for each symbol, (ii) a set of symbols with a single projection for each symbol, (iii) a single symbol with a set of projections for the symbol, and (iv) a single symbol with a single projection.

The theoretical yield is as a yield on the capital that is held. The theoretical return on capital yield is based on buying power or capital that is held instead of being based on a risk metric. Therefore, the amount entered by the user may be limited based on the user's buying power. However, in various implementations, the user may opt to use the user-guided options generation application to compare theoretical yields exclusively based on the amount entered and not the user's buying power according to their account parameters.

On the trajectory screen 220, the user may draw on a graph of the entered stock symbol 224 a projected trajectory 228 from today to a future date. In various implementations, the future date is not a specific date and instead, for example, a general future trend. As shown in the graph of the entered stock symbol 224, the future date is 60 days in the future. The user connects the projected trajectory 228 with a historical trajectory 232 of the entered stock symbol. In various implementations, the trajectory screen 220 of FIG. 2B may include two fields of entry: an estimated future value at a future date. Therefore, instead of having the user draw on the graph to estimate stock trajectory, the user may simply enter the estimated future value of the entered symbol at 60 days in the future and the user-guided options generation application will assume a constant rate of growth or decline towards the estimated future value. Alternatively, the user can define a shaded area or region, indicating that they are estimating the future value will remain in a bounded range. Once the graph of the entered stock symbol 224 is completed, the user selects a show options button 236 to view the variety of options.

FIG. 2C depicts a results screen 240 displaying the variety of options. The user may scroll through the options provided for display. In FIG. 2C, a first option 244 and part of a second option 248 are shown. The first option 244 shows that 100 shares of the first option would have to be purchased to receive a theoretical or annual yield of 325% with a probability of 61% as compared to a stock yield of 41% if the user were to purchase the stock. In other words, based on the estimated future value of the stock at the future date, the first option would provide a 325% return of the original investment (the price of the 100 stock options) with a likelihood of 61%.

Otherwise, if the user were to purchase 100 stocks of the stock, the user would receive a 41% return of the original investment (the price of 100 stocks) with a likelihood of 61%. Upon selection of a more information button 252, the display may include additional information about the option, including a close date, a max loss (which may be the amount originally submitted by the user), a purchase price of the option, and a stock volatility. Additionally, the display may include the annual yield and the stock yield in dollar values.

### Generation System

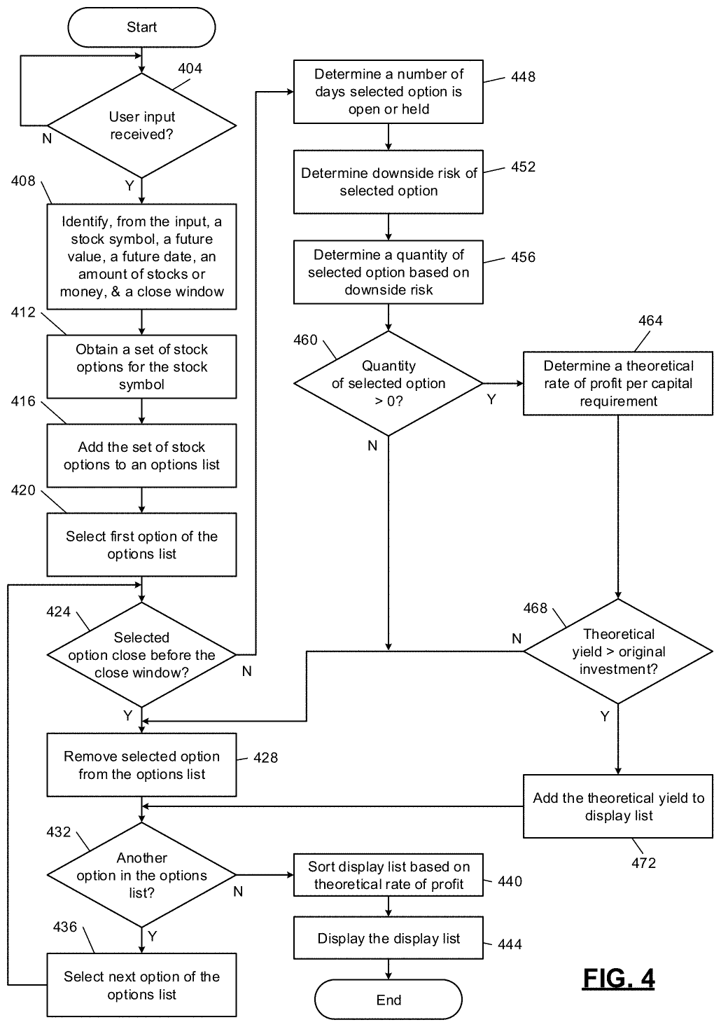

Referring to FIG. 3, a functional block diagram of an example user-guided generation module 112 is shown. The user-guided generation module 112 receives user input from, for example, a user device. The user input includes: a stock, a future value, a future date, and an amount. In various implementations, the user input may include a close window indicating a time period before an option expiration that the user would like to sell the option. When the user input includes the close window, for example, two weeks, then the user-guided generation module 112 sets the future date of each option to the sooner of the two: the future date or two weeks prior to the expiration of the corresponding option.

The user-guided generation module 112 includes a data gathering module 304 that receives the user input. The data gathering module 304 obtains an account amount of an account of the user as well as trade fees from an account parameter database 308. The data gathering module 304 also obtains a set of stock options for the selected stock from a stock & option parameter database 312 along with stock parameters. The data gathering module 304 also obtains from the stock & option parameter database 312, for each stock option, an expiration date.

A filtering module 314 is placed between the data gathering module 304 and a determination module 316 to remove options that expire prior to the close window from the set of stock options that are analyzed by the determination module 316. For example, if the close window is 14 days and one of the stock options expires in 9 days, that stock option is removed from the set of stock options since the user would not want to purchase that stock option. The filtered data is then forwarded to the determination module 316, which is configured to determine a theoretical yield of the remaining options in the set of stock options and a probability or risk associated with each stock option.

In an example, the user input may include stock symbol ABCD and estimate that the stock symbol, presently at 130, will travel towards 145 during a 60 day period. The user input will also include an amount, a—either an amount of money that the user is willing to risk or a number of stocks the user would otherwise invest in the stock symbol. The user input may also include a close window, indicating a number of days before expiration of an option that the user sets to sell the stock option. In various implementations, if the user does not specify, the user-guided generation module 112 automatically sets the close window to two weeks prior to expiration.

First, the data gathering module 304 obtains a set of stock options for the inputted stock (e.g., ABCD) from the stock & option parameter database 312, including a strike price of each option and an expiration date of each option. The data gathering module 304 also obtains stock data including a present stock value. Then, the filtering module 314 removes stock options that expire prior to the close window (e.g., any stock option expiring within 14 days) and forwards the remaining set of stock options to the determination module 316. In various implementations, the filtering module 314 can filter by, based on the user's account parameters, buying power effect, maximum loss, etc.

For the determination module 316 to determine a theoretical yield for each stock option, the determination module 316 calculates a required rate of return, r, of the stock and well as commission fees. The required rate of return is determined from a risk-free rate of the stock less a yield. The risk-free rate is a theoretical rate of return of investment with zero risk. The yield is an amount by which the stock is degraded over time. Then, based on the trade fees obtained from the account parameter database 308 (and any other fees associated with a trade, such as contract fees, commission, etc.), the determination module 316 determines a trade cost by summing the trade fees.

The determination module 316 also determines, for each option of the set of options, a theoretical yield. For example, determining the theoretical yield of a first stock option will be explained. The determination module 316 calculates a slope of the estimated future value of the stock as projection, p, and a number of days to hold the first stock option: h. The slope of the projection, p, is a difference in today's price and the future price divided by a difference in a number of days between today and the future date when the stock will reach the future price. As described previously, the projection or trajectory is input by the user.

The number of days, h, is a date to sell the first stock option less the present date. The date to sell the first stock option is either (i) the future date (from the user input) or (ii) the first stock option expiration date less the close window (also from the user input).

The determination module 316 also calculates a one standard deviation downside risk of the first stock option, d, and a quantity, q, of the first stock option based on the downside risk. The downside risk, d, is the amount, a, if the amount is a monetary value. Otherwise, if the user entered a number of stocks as the amount, a, the downside risk, d, can be calculated using Equation 1, below:

$$d = a * S ( \frac{σ \sqrt{T - t}}{2} )$$

where S is a present stock value, a is the stock volatility, T is a present date, and t is the future date. The cost of the number of stocks, a, is multiplied by one standard deviation downside risk, which represents an estimation of the stocks probability of declining one standard deviation, representing a reasonable monetary amount the user if willing to risk.

The determination module 316 determines the quantity, q, of the first stock option the user can reasonably purchase based on the amount of money the user is willing to risk, which is the downside risk, d (or the amount value if the user entered a monetary amount). The quantity, q, is determined by obtaining, from the stock & options parameter database 312, a multiplier, m, of the first stock option and a strike price, X, of the first stock option (an asking price of the first option). The quantity is calculated using Equation 2, below:

$$q = X \frac{d}{m}$$

As long as q is greater than zero, indicating that the user can purchase the first stock option without exceeding the amount the user is willing to risk, then the determination module 316 calculates the theoretical yield. However, if q is less than zero, the determination module 316 removes the first stock option from the set of stock options.

Assuming q is greater than zero, the determination module 316 determines the theoretical yield based on a difference between the theoretical value at the future date and the theoretical value at the present date. Both theoretical values are calculated using the Black-Scholes pricing model. The theoretical value is used at both time points to account for any potential discrepancy between the theoretical value today versus the actual price today.

The theoretical value at the future date, f, is shown below in Equation 3:

$$f = \frac{ln ( \frac{S * c * p}{X} ) + h * ( r + \frac{{σ}^{2}}{2} )}{σ \sqrt{h}}$$

where c is the close window input by the user or assumed by the determination module 316. The theoretical value at today's date, y, is shown below in Equation 4:

$$y = \frac{ln ( \frac{S}{X} ) + ( T - t ) ( r + \frac{{σ}^{2}}{2} )}{σ \sqrt{T - t}}$$

Then, the theoretical yield is the quantity, q, to purchase, multiplied by the theoretical value at the future date less the theoretical value at the present date. Then, any trade fees associated with the trade can be subtracted from the total theoretical yield, as shown in Equation 5, below:

q*(f−y)−trade fees

The determination module 316 can further determine a per diem rate of profit by dividing the theoretical yield by the number of days the first stock option is being held, h. Then, the determination module 316 can filter out any stock options of the set of stock options that would return less than the original investment. The original investment can be represented as the quantity, q, multiplied by the cost of the stock, S, plus the trade costs. The determination module 316 would determine if the theoretical yield would be less than the original investment, so that the user is not presented with options where the user would lose money.

The determination module 316 can further calculate the theoretical yield as a percentage by dividing the theoretical yield by today's stock price and multiplying the value by 100. In various implementations, the determination module 316 may also calculate a probability that the stock will reach the future price by the future date based on today's stock price, the future price, remaining days held (represented as h), and stock volatility. The determination module 316 can also calculate a stock yield as a percentage by dividing the future price by today's stock price and multiplying by 100.

Once the determination module 316 has calculated the theoretical yield overall and per diem, the results are forwarded to a sorting module 320 to sort the set of stock options in descending order of profit. Then, the sorted list is forwarded to the user device 104 for display. Optionally, the sorting module 320 selects a highest stock option with a highest theoretical yield and forwards the highest stock option to an actuation module 324. The actuation module 324 is configured to purchase the highest stock option and set the highest stock option to be sold after the holding time, h, expires. Then, the user-guided generation module 112 displays to the user device, the highest stock option and date at which the highest stock option will automatically be sold (today's date+h).

In various implementations, the user-guided generation module 112 may determine a theoretical yield for a set of stock options for each day until the future date. Then, based on the theoretical yield and/or the probability of each calculation, the user-guided generation module 112 can identify a stock option with a highest theoretical yield and a corresponding high probability as well as recommend a selling date for the stock option.

While the above examples are provided for purchase of a set of stock options, the user-guided generation module 112 can also determine a put stock option, identifying a sell date and value according to the user-estimated parameters.

As previously described, in an example implementations, the user-guided options generation application may receive user input in the form of shading an area on a graph of a stock, indicating a bounded region that the user believes the stock price will remain. In a shading scenario, the user-guide options generation module 112 can identify the price ranges at a plurality of future dates to determine corresponding theoretical yields and probabilities at each future date and price range. Then, the sorting module 320 can sort based on the probability that the stock will reach the estimated future prices. Additionally or alternatively, as described previously, the user-guided generation module 112 can sort the stock options based on theoretical yield, selecting a highest subset of theoretical values to display to the user.

### Flowcharts

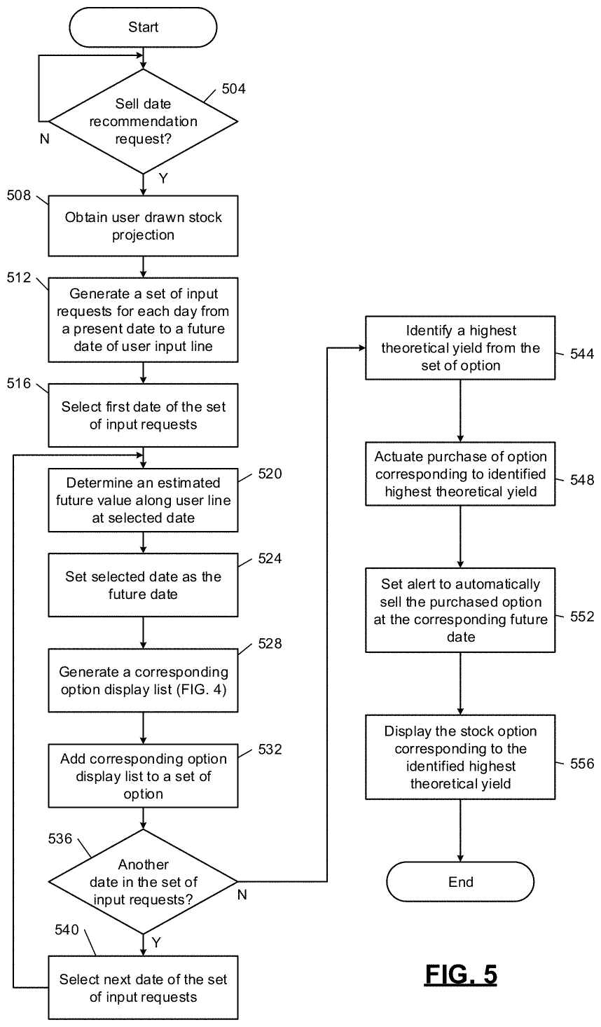

Referring to FIG. 4, a flowchart depicting example results generation and display is shown. Control begins at 404 to determine whether user input has been received. If no, control waits. Otherwise, control continues to 408 to identify, from the user input, a stock symbol, a future value, future date, an amount of stocks or money, and a close window. Then, control continues to 412 to obtain a set of stock options corresponding to the received stock symbol. At 416, control adds the set of stock options to an option list. At 420, control selects a first option of the options list.

Control proceeds to 424 to determine if the selected option closes or expires prior to the close window. That is, control determines if the expiration date of the selected first option is before the close window. For example, if the expiration date of the selected option is in nine days and the close window is two weeks, then selected stock option closes before the close window. Therefore, control continues to 428 to remove the selected option from the options list. In various implementations, instead of using an options list and removing options from the list, control may simply skip the selected option once control determines the selected option is not viable.

Then, control proceeds to 432 to determine whether the options list includes another option. If yes, control continues to 436 to select the next option of the options list and returns to 424. Otherwise, if the options list is empty, control proceeds to 440 to sort the display list based on theoretical rate of profit or theoretical yield. As described with respect FIG. 3, the display list may be sorted according to a variety of parameters. Then, control continues to 444 to display the display list on a user device. Then, control ends.

Returning to 424, if the selected option does not close before the close window, control continues to 448 to determine a number of days that the selected option remains open or held based on the future date and the close window. As previously described, the number of remaining days is the difference between today's date and the future date. In various implementations, if the selected option expires prior to the future date (or expires within the close window of the future date), then the number of remaining days the difference between today's date and the close window of the selected options expiration date.

Then, control proceeds to 452 to determine a downside risk of the selected option. In the example described above, the downside risk may be determined as one standard deviation of the downside risk. The downside risk is a monetary amount that the user has indicated they are willing to risk. Control continues to 456 to determine a quantity of the selected option to purchase based on the downside risk. That is, since control determined the amount the user is willing to lose, control then determines the quantity of the selected option that the user can buy considering that the user is willing to risk the amount of the determined downside risk. Then, control continues to 460 to determine if the quantity of the selected option is greater than zero. As described above, if the cost of the stock is greater than the amount that the user's willing to risk, then control does not calculate the theoretical yield as the cost already exceeds an amount that the user is willing to use to purchase the selected option.

If the quantity of the selected option is not greater than zero, control proceeds to 428. Otherwise, control continues to 464 to determine a theoretical yield and a per diem theoretical rate of profit. Then, control proceeds to 468 to determine whether theoretical yield is greater than the original investment. If no, then the theoretical yield indicates that the user will lose money. Therefore control returns to 428 to remove the selected option from the option.

Otherwise, if the theoretical yield is greater than the original investment, control proceeds to 472 to add the theoretical yield to a display list, indicating that the selected option, along with the theoretical yield and additional parameters, will be displayed as a purchase option to the user. Then, control returns to 432 to determine if another option is included in the options list. In various implementations, control may actuate the purchase of the stock option with the highest theoretical yield and set an alert to sell the stock option by the future date or the close date prior to the expiration of the stock option, whichever is sooner.

Referring to FIG. 5, a flowchart depicting example actuation of purchase and sale of an option is shown. Control begins at 504 to determine whether a sell date recommendation request was received. The sell date recommendation request may include a user selection of the corresponding stock, an amount of stocks or money, and a close window along with the requested sell date recommendation. If the sell date recommendation request is not received, control waits. Otherwise, control continues to 508 to obtain the user drawn stock projection line on a graph of the stock symbol. In various implementations, the user may select the stock to view and then draws the estimated stock projection.

Control proceeds to 512 to generate a set of input requests for each day from the present date to the future date. Control proceeds to 516 to select a first date of the set of input requests. At 520, control determines an estimated future value along the user drawn stock projection at the selected date. That is, control determines the estimated future value of the user drawn line at the selected date. Then, control continues to 524 to set the selected date as the future date.

Control proceeds to 528 to generate a corresponding option display list, as described in FIG. 4. Then, control continues to 532 to add the corresponding option display list to a set of options. Control proceeds to 536 to determine whether another date is in the set of input requests. If yes, control continues to 540 to select a next date of the set of input requests and returns to 520. Otherwise, control proceeds to 544 to identify a highest theoretical yield from the set of options.

Then, control continues to 548 actuate a purchase of the option corresponding to the identified highest theoretical yield. Control proceeds to 552 to set an alert to automatically sell the purchased option at the corresponding future date. Control proceeds to 556 to display the stock option having the identified highest theoretical yield.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A system comprising:
at least one processor and
a memory coupled to the at least one processor,
wherein the memory stores:
a stock and option parameter database including a plurality of options, wherein each option of the plurality of options includes a corresponding stock identifier, a value, a multiplier, and an expiration date; and
instructions for execution by the at least one processor and
wherein the instructions include, in response to receiving user parameters including a stock identifier, a future value, a future date, a close window, and a requested amount, wherein the requested amount corresponds to a number of shares in the stock that the user is willing to risk, and wherein the future value and future date is received in response to a user-drawn stock projection line on a graph for the stock identifier:
obtaining a set of options based on the stock identifier from the stock and option parameter database;
for each option of the set of options:
calculating a one-standard-deviation downside risk d of the option, wherein:
$$d = a * S ( \frac{σ \sqrt{T - t}}{2} ) ,$$
a is the number of shares in the stock that the user is willing to risk,
S represents a present value of the stock,
σ represents volatility of the stock,
T is the current date, and
t is the future date;
in response to an expiration date of the option being after the future date, determining an acquired quantity q of the option based on the requested amount, wherein:
$$q = X \frac{d}{m} ,$$
X is the value of the option, and
m is the multiplier of the option;
in response to the acquired quantity being greater than zero, determining a theoretical yield based on a difference between a theoretical future value f and a theoretical present value y, wherein:
$$f = \frac{ln ( \frac{S * c * p}{X} ) + h * ( r + \frac{{σ}^{2}}{2} )}{σ \sqrt{h}} , \\ y = \frac{ln ( \frac{S}{X} ) + ( T - t ) ( r + \frac{{σ}^{2}}{2} )}{σ \sqrt{T - t}} ,$$
c is the close window,
r is a required rate of return determined from a risk-free rate of the stock less a yield, wherein the risk-free rate of return is determined a theoretical rate of return of investment with zero risk, and the yield is an amount by which the stock is degraded over time, and
h=t−T; and
in response to the theoretical yield being greater than a beginning value, adding the option to a candidate list;
sorting the candidate list based on the theoretical yield of each option in the candidate list; and
outputting the candidate list to a user device.

2. The system of claim 1 wherein outputting includes outputting an aural representation of at least one option of the candidate list via a speaker of the user device.

3. The system of claim 1 wherein outputting includes outputting a graphical representation of at least one option of the candidate list via a display screen of the user device.

4. The system of claim 1 wherein:
the instructions include identifying a highest option from the candidate list and
the highest option includes a highest theoretical yield among the options in the candidate list.

5. The system of claim 4 wherein only the highest option is initially output via the user device.

6. The system of claim 4 wherein the instructions include automatically actuating a purchase of an option corresponding to the highest option.

7. The system of claim 1 wherein the instructions include displaying the sorted candidate list.

8. The system of claim 1 wherein the theoretical future value and the theoretical present value are based on a Black-Scholes model.

9. The system of claim 1 wherein the instructions include:
automatically setting an alert to actuate a sale on the future date.

10. The system of claim 1 wherein:
the memory stores an account parameter database including a plurality of accounts, wherein each account of the plurality of accounts includes an amount of available funds,
the user parameters include a requesting account of the plurality of accounts, and
the requested amount is determined based a requesting amount of available funds included in the requesting account.

11. The system of claim 1 wherein the user parameters are received as user input via the user device.

12. A computerized method comprising:
in response to receiving, by a processor, user parameters including a stock identifier, a future value, a future date, a close window, and a requested amount wherein the requested amount corresponds to a monetary amount that the user is willing to risk on the stock, and wherein the future value and future date is received in response to a user-drawn stock projection line on a graph for the stock identifier:
obtaining, by the processor, a set of options based on the stock identifier from a stock and option parameter database, wherein the stock and option parameter database includes a plurality of options, and wherein each option of the plurality of options includes a corresponding stock identifier, a value, a multiplier, and an expiration date;
for each option of the set of options:
calculating a one-standard-deviation downside risk d of the option as the monetary amount a that the user is willing to risk:
in response to an expiration date of the option being after the future date, determining, by the processor, an acquired quantity of the option based on the requested amount, wherein:
$$q = X \frac{d}{m} ,$$
X is the value of the option, and
m is the multiplier of the option;
in response to the acquired quantity being greater than zero, determining, by the processor, a theoretical yield based on a difference between a theoretical future value f and a theoretical present value y, wherein:
$$f = \frac{ln ( \frac{S * c * p}{X} ) + h * ( r + \frac{{σ}^{2}}{2} )}{σ \sqrt{h}} , \\ y = \frac{ln ( \frac{S}{X} ) + ( T - t ) ( r + \frac{{σ}^{2}}{2} )}{σ \sqrt{T - t}} ,$$
c is the close window,
r is a required rate of return determined from a risk-free rate of the stock less a yield, wherein the risk-free rate of return is determined a theoretical rate of return of investment with zero risk, and the yield is an amount by which the stock is degraded over time,
a is the number of shares of the stock that the user is willing to risk,
S represents a present value of the stock,
σ represents volatility of the stock,
T is the current date,
t is the future date, and
h=t−T; and
in response to the theoretical yield being greater than a beginning value, adding, by the processor, the option to a candidate list;
sorting the candidate list based on the theoretical yield of each option in the candidate list; and
outputting, by the processor, the candidate list to a user device.

13. The method of claim 12 further comprising:
outputting an aural representation of at least one option of the candidate list via a speaker of the user device; or
outputting a graphical representation of at least one option of the candidate list via a display screen of the user device.

14. The method of claim 12 further comprising:
identifying a highest option from the candidate list, wherein the highest option includes a highest theoretical yield among the options in the candidate list.

15. The method of claim 14 wherein only the highest option is initially output via the user device.

16. The method of claim 14 further comprising:
automatically actuating a purchase of an option corresponding to the highest option; or
automatically setting an alert to actuate a sale on the future date.

17. The method of claim 12 further comprising:
sorting the candidate list based on a theoretical value of each option of the set of options; and
displaying the sorted candidate list.

18. The method of claim 12 wherein the theoretical future value and the theoretical present value are based on a Black-Scholes model.

19. The method of claim 12 further comprising:
storing a plurality of accounts, wherein each account of the plurality of accounts includes an amount of available funds, and wherein:
the user parameters include a requesting account of the plurality of accounts, and
the requested amount is determined based a requesting amount of available funds included in the requesting account.

20. The method of claim 12 wherein the user parameters are received as user input via the user device.
